(19) United States
(12) Patent Application Publication
(10) Pub. No.: US 2007/0101170 A1
(43) Pub. Date: May 3, 2007

(54) UPS WAKE ON LAN

(76) Inventor: R. Scott Baer, Columbus, OH (US)

Correspondence Address: LOCKE LIDDELL & SAPP LLP;ATTN. DOCKETING, 600 TRAVIS #3400, HOUSTON, TX, 77002, US

(21) Appl. No.: 11/538,733

(22) Filed: Oct. 4, 2006

Related U.S. Application Data
(60) Provisional application No. 60/596,579, filed on Oct. 4, 2005.

(51) Int. Cl. G06F 1/00

(52) U.S. Cl. 713/300

(57) ABSTRACT

A method of powering a computer system using an uninterruptible power supply (UPS) system includes sending a shut down signal from the UPS system to the computer system. The computer is then shut down in response to the shut down signal. When AC power is restored to the UPS system, the UPS system provides power to the computer system and the UPS system sends a wake up signal to the computer system. The computer system is then powered up in response to the wake up signal.

### CROSS REFERENCE TO RELATED APPLICATIONS

This application is a non-provisional application of, and claims priority to, U.S. Provisional Application No. 60/596,579, filed on Oct. 4, 2005, the entire contents of which are incorporated by reference herein for all purposes.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The present invention relates generally to uninterruptible power supply (“UPS”) systems.

1. Description of the Related Art

UPS systems are often used to provide continuous or uninterrupted power to a load in applications that require continuity of power, such as in hospitals and critical processes in both industrial and commercial settings, such as protecting equipment from power failure and interference from blackouts, brownouts, surges, and noise. A typical UPS system generally includes a rectifier, a battery, and an inverter. In the event of an interruption of utility power, the critical load will be supplied by DC power from the batteries in the UPS modules. This DC power is converted to AC power by the inverters in the UPS system before being passed to the load.

In computer systems backed-up by a UPS, a powered down situation occurs when a combination of a UPS system and monitoring system shut down the computer system when utility power is lost. The UPS system notifies the computer system to power down, allowing the computer system to perform an orderly shutdown on UPS-supplied AC power before the UPS-supplied AC power is lost. However, computers shut down in this manner may not restart when utility power is restored and manual intervention is required to restart the computers.

U.S. Pat. Nos. 5,938,771; 6,701,442; 6,591,368; 6,052,793 and 6,408,397 disclose various power management systems and methods, including “wake up” functionality, for computer systems. Conventional UPS systems, however, typically do not include functionality that allows for the automated or unattended power-up of the load when utility power is restored to the UPS.

The inventions disclosed and taught herein are directed to improved systems and methods for automated, unattended power-up of UPS-supplied loads when utility power is restored.

### BRIEF SUMMARY OF THE INVENTION

A method of powering a computer system using an uninterruptible power supply (UPS) system comprises sending a shut down signal from the UPS system to the computer system. The computer system is shut down in response to the shut down signal. When power is restored to the UPS system, the UPS system provides power to the computer system and the UPS system sends a wake up signal to the computer system. The computer system is then powered up in response to the wake up signal.

### BRIEF DESCRIPTION OF THE SEVERAL VIEWS OF THE DRAWINGS

FIG. 1 illustrates a computer system including a UPS.

FIG. 2 illustrates a UPS.

FIG. 3 illustrates an exemplary method in accordance with aspects of the invention.

### DETAILED DESCRIPTION

The Figures described above and the written description of specific structures and processes below are not presented to limit the scope of what Applicant has invented or the scope of protection for those inventions. Rather, the Figures and written description are provided to teach any person skilled in the art to make and use the inventions for which patent protection is sought. Those skilled in the art will appreciate that not all features of a commercial implementation of the inventions are described or shown for the sake of clarity and understanding. Persons of skill in this art also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. The inventions disclosed and taught herein are susceptible to numerous and various modifications and alternative forms. The use of a singular term is not intended as limiting of the number of items. Also, the use of relational terms, such as, but not limited to, “top,” “bottom,” “left,” “right,” “upper,” “lower,” “down,” “up,” “side,” and the like are used in the written description for clarity in reference to the specific Figures disclosed and are not intended to limit the scope of the invention or the appended claims.

In general terms, Applicants have invented a method of powering a computer system using an uninterruptible power supply (UPS) system comprising sending a shut down signal from the UPS system to the computer system or on the occurrence of a predetermined event. The computer system is then shut down in response to the shut down signal. When power is restored to the UPS system, the UPS system provides power to the computer system and sends a wake up signal to the computer system. The computer system then powers up in response to the wake up signal.

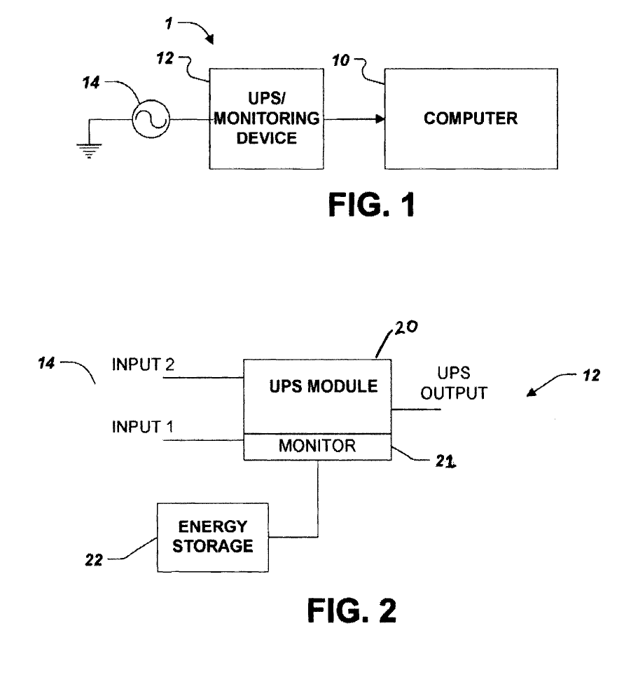

FIG. 1 illustrates an exemplary computer system 1. The system 1 includes a computer system 10 powered via an uninterruptible power supply (UPS) system 12 that is connected to a source of AC power 14, such as that provided by a utility. The computer 10 may comprise, for example, a plurality of networked computers or a single computer. FIG. 2 illustrates aspects of the UPS system 12 illustrated in FIG. 1. One or more input power lines are connected to a UPS module 20, and an energy storage device 22 is connected to the UPS module. Preferably, the energy storage device 22 comprises one or more batteries, though other suitable devices such as a flywheel or fuel cells may be used. If the input power 14 fails, the energy storage device 22 provides power to the UPS module 20. Power from the energy storage device 22 may be required when power from the AC power source 14 is performing outside of acceptable limits or fails completely.

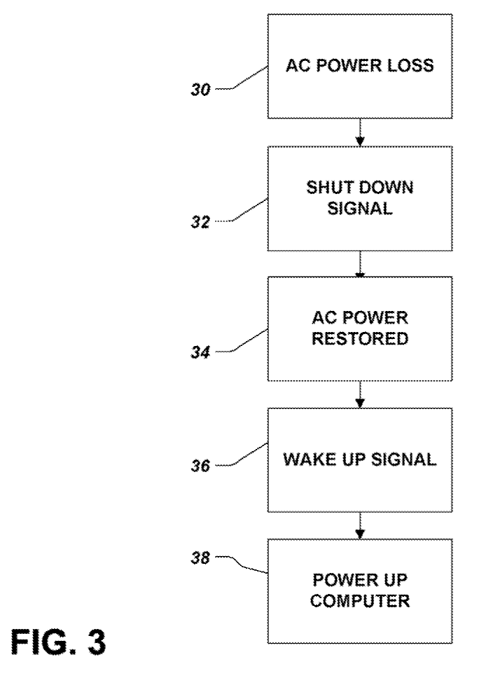

The UPS module 20 includes a monitoring system 21 that, among other things, monitors a power attribute, such as the voltage, of the UPS energy storage device 22. The monitoring system 21 of the UPS 12 further monitors the status of the computers 10. The UPS 12 includes a processing device, such as an appropriately programmed microprocessor. FIG. 3 is a flow diagram generally illustrating a preferred method executed by the processing device of the UPS 12 for automated power-up of the computer 10 once AC power 14 has been restored to the UPS 12.

After loss of the AC power 14 in block 30, the UPS system 12 powers the computer system 10 using the energy storage device 22. Upon some predetermined condition, such as the voltage of the energy storage device 22 falling below a threshold level, the monitoring device 21 of the UPS system 12 sends a signal to the computer 10 to shut down, as illustrated in block 32. In response to the signal from the monitoring device 21, the computer 10 performs its shut down routine.

Most computer systems and network cards support “wake up” features, such as the “Magic Packet” scheme, in which a network message is sent from a network interface to a computer that has been powered down. In accordance with the teachings of the present disclosure, the UPS system 12 includes a wake up feature, such as Magic Packet. When the AC power 14 is restored to the UPS 12 (block 34), the UPS 12 again supplies power to the computers. The monitoring device 21 of the UPS 12 sends a wake up signal (block 36), such as a Magic Packet to the computer 10, in response to which the computer 10 begins its power up routine (block 38).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Consequently, all such similar applications are considered within the scope and spirit of the invention. Accordingly, the protection sought herein is as set forth in the claims below.

Other and further embodiments within the scope of Applicant's invention can be devised by those skilled in the art, now having the benefit of this disclosure. For example, the UPS processing drive may comprise memory devices to log the various events, such as loss of AC Power 14, performance and length of battery back up by the UPS, and other such items of interest.

The order of steps can occur in a variety of sequences unless otherwise specifically limited. The various steps described herein can be combined with other steps, interlineated with the stated steps, and/or split into multiple steps. Similarly, some elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of powering a computer system using an uninterruptible power supply (UPS) system, comprising:
sending a shut down signal from the ups system to the computer system;
shutting down the computer system in response to the shut down signal;
supplying power from the ups system to the computer system;
sending a wake up signal from ups system to the computer system; and
powering up the computer system in response to the wake up signal.

2. The method of claim 1, further comprising supplying primary ac power from an ac power source to the UPS system.

3. The method of claim 2, wherein the shut down signal is sent from the UPS system to the computer system in response to losing the primary ac power source.

4. The method of claim 3, wherein the wake up signal is sent from the UPS system to the computer system in response to the primary ac power source being restored.

5. The method of claim 1, wherein supplying power from the UPS system includes supplying power from an energy storage device.

6. The method of claim 5, wherein supplying power from the energy storage device comprises supplying power from a battery.

7. An uninterruptible power supply (UPS) system, comprising:
an input for receiving primary ac power;
an output connectible to a computer system for providing power to the computer system; and
a monitoring device, programmed to send a shut down signal from the ups system to the computer system in response to a failure of the primary ac power, and after the primary ac power is restored, send a wake up signal from the ups system to the computer system.

8. The UPS system of claim 7, wherein failure of the primary ac power is selected from the group consisting of: a complete loss of primary ac power; a partial loss of primary ac power; and a degradation of one or more primary ac power attributes from a predetermined ac power standard.

9. The ups system of claim 7, further comprising an energy storage device for providing power to the computer system if the primary ac power fails.

10. The UPS system of claim 8, wherein the energy storage device includes a battery.

11. The UPS system of claim 7, wherein the computer system comprises a plurality of computers.
